(19) United States
(12) Patent Application Publication
(10) Pub. No.: US 2018/0206479 A1
(43) Pub. Date: Jul. 26, 2018

(54) Hunting Blind System

(71) Applicant: James Hosmer, Bessemer, AL (US)

(72) Inventor: James Hosmer, Bessemer, AL (US)

(21) Appl. No.: 15/413,576

(22) Filed: Jan. 24, 2017

(51) Int. Cl. A01M 31/02; E04H 15/00; E06B 7/30; E06B 9/24; G02B 27/28

(52) U.S. Cl. CPC A01M 31/025; E04H 15/001; G02B 27/281; E06B 7/30; E06B 9/24; E04H 15/008

(57) ABSTRACT

A hunting blind system includes a structure that may house a hunter. The housing has a first opening extending into an interior of the structure. A weapon is selectively extended through the first opening for hunting. A shield unit is positioned within the structure such that the shield unit covers the first opening. The shield unit is comprised of a polarized material to pass light therethrough in a single direction. In this way the window inhibits prey from seeing through the shield unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to hunting devices and more particularly pertains to a new hunting device for inhibiting prey from seeing into a hunting blind.

### BRIEF SUMMARY OF THE INVENTION

An embodiment of the disclosure meets the needs presented above by generally comprising a structure that may house a hunter. The housing has a first opening extending into an interior of the structure. A weapon is selectively extended through the first opening for hunting. A shield unit is positioned within the structure such that the shield unit covers the first opening. The shield unit is comprised of a polarized material to pass light therethrough in a single direction. In this way the window inhibits prey from seeing through the shield unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an interior perspective view of a hunting blind system according to an embodiment of the disclosure.

FIG. 2 is a perspective view of shield unit of an embodiment of the disclosure.

FIG. 3 is an interior perspective in use view of an embodiment of the disclosure.

FIG. 4 is an exterior perspective in-use view of an embodiment of the disclosure.

### DETAILED DESCRIPTION OF THE INVENTION

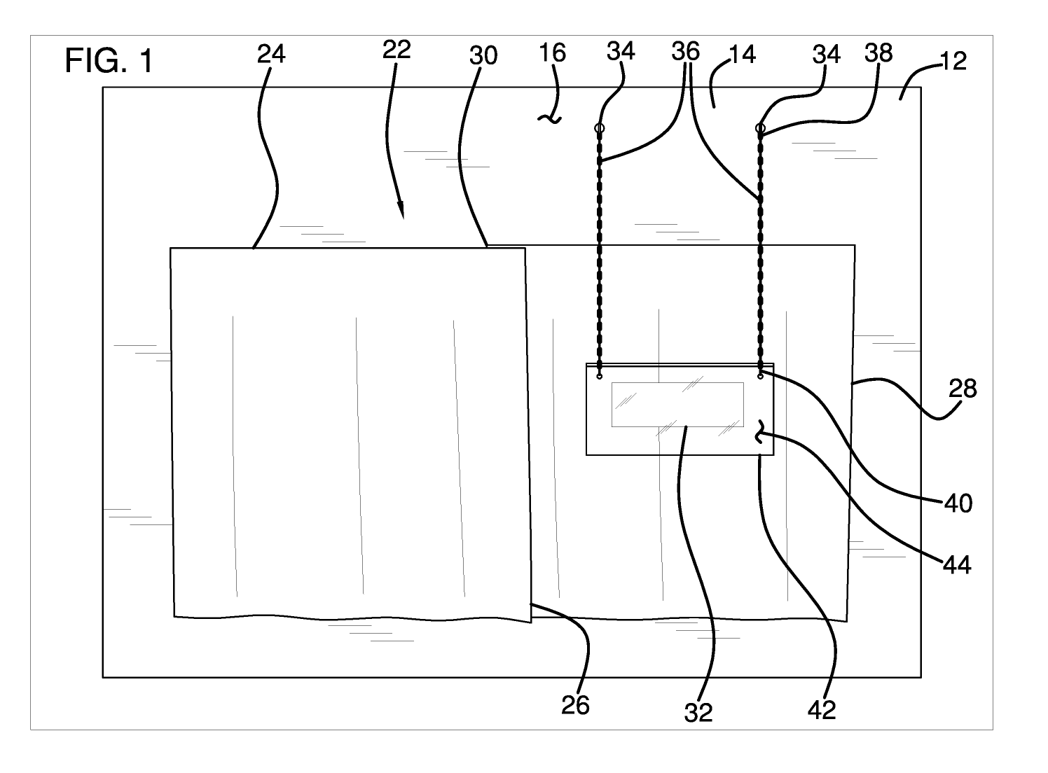

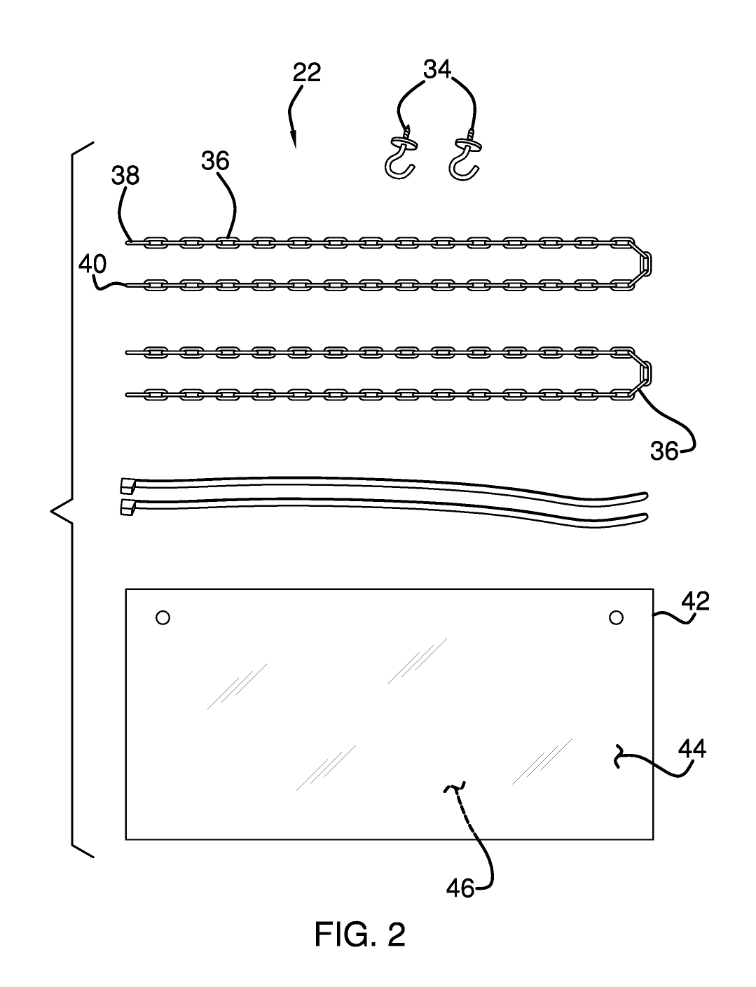

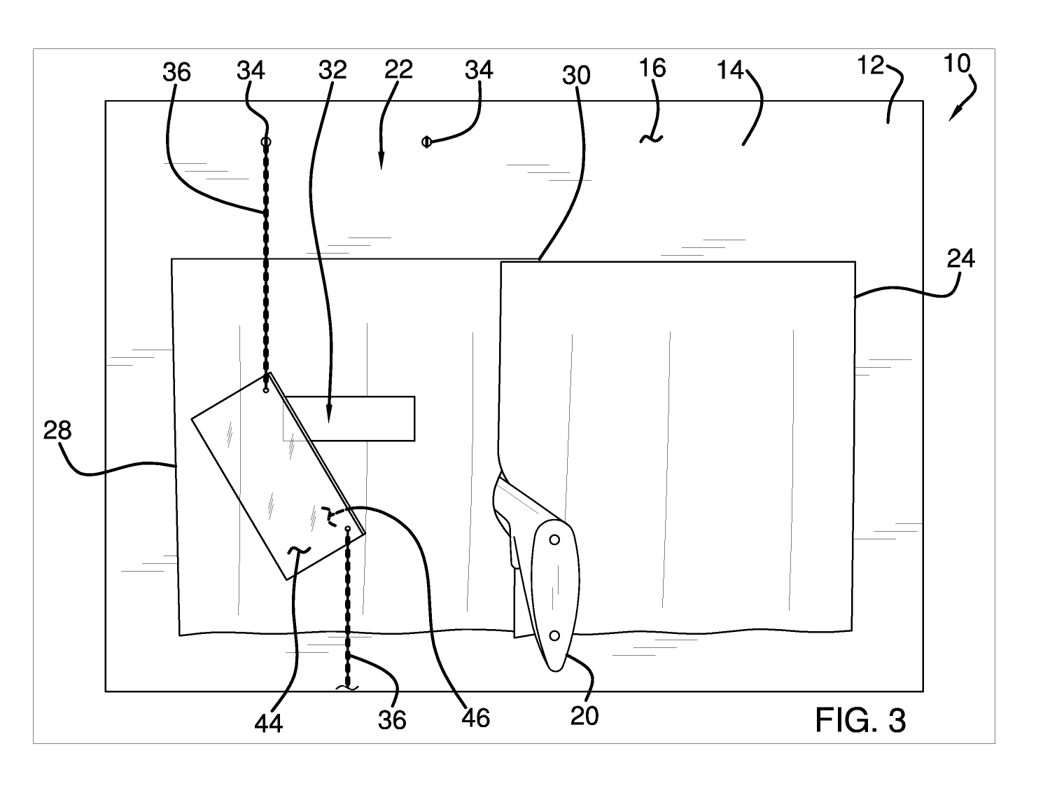

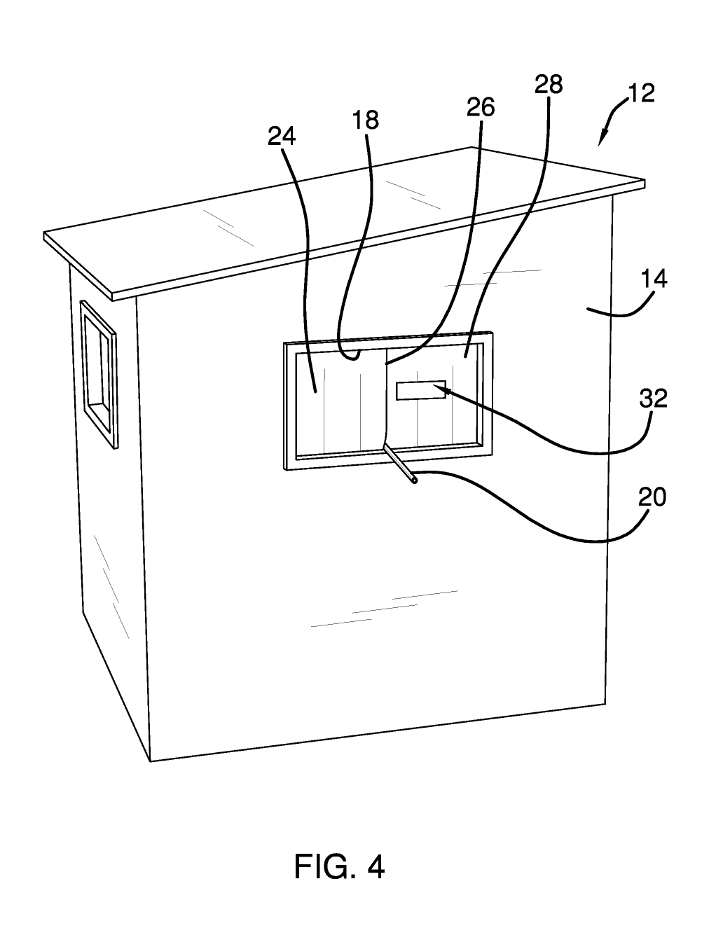

With reference now to the drawings, and in particular to FIGS. 1 through 4 thereof, a new hunting device embodying the principles and concepts of an embodiment of the disclosure and generally designated by the reference numeral 10 will be described.

As best illustrated in FIGS. 1 through 4, the hunting blind system 10 generally comprises a structure 12 that may house a hunter. The structure 12 has a perimeter wall 14 and the perimeter wall 14 has an inside surface 16. The perimeter wall 14 has a first opening 18 extending into an interior of the structure 12. Moreover, a weapon 20 may be extended through the first opening 18 for hunting. The structure 12 may be a rigid hunting blind or the like and the weapon 20 may be a rifle, a bow and arrow or other hunting weapon.

A shield unit 22 is provided and the shield unit 22 is positioned within the structure 12 such that the shield unit 22 covers the first opening 18. The shield unit 22 is comprised of a polarized material to pass light therethrough in a single direction. In this way the shield unit 22 inhibits prey from seeing through the shield unit 22.

The shield unit 22 comprises a first curtain 24 that is suspended on the inside surface 16 of the structure 12. The first curtain 24 has a first lateral edge 26 and he curtain is positioned such that the first lateral edge 26 is aligned with the first opening 18 in the structure 12. A second curtain 28 is suspended on the inside surface 16 of the structure 12. The second curtain 28 has a first lateral edge 30 and the second curtain 28 is positioned such that the first lateral edge 30 of the second curtain 28 is aligned with the first opening 18 in the structure 12. Each of the first curtain 24 and the second curtain 28 facilitates the weapon 20 to be extended between the first lateral edge 26 of the first curtain 24 and the first lateral edge 30 of the second curtain 28.

The second curtain 28 has a second opening 32 extending therethrough. The second opening 32 is aligned with the first opening 18 to facilitate the prey to be visible through the second opening 32 and the first opening 18. A pair of fasteners 34 is provided and each of the fasteners 34 is selectively coupled to the inside surface 16 of the structure 12. Each of the fasteners 34 is positioned above the first opening 18 and each of the fasteners 34 may be a threaded hook or the like.

A pair of chains 36 is provided and each of the chains 36 has a first end 38 and a second end 40. The first end 38 corresponding to each of the chains 36 is releasably coupled to an associated one of the fasteners 34. Alternatively, a pair of cables, ropes or other means of suspension may be provided in lieu of the chains 36.

A window 42 is provided and the window 42 is coupled to the second end 40 corresponding to each of the chains 36. The window 42 has a first surface 44 and a second surface 46. Moreover, the window 42 is coupled to the second end 40 corresponding to each of the chains 36 having the first surface 44 facing an interior of the structure 12. The window 42 is aligned with each of the first opening 18 and the second opening 32.

The window 42 is comprised of a polarized material. Thus, light may pass between the first surface 44 and the second surface 46. Moreover, light is inhibited from passing between the second surface 46 and the first surface 44. In this way the window 42 inhibits the prey from seeing into the structure 12. The window 42 may be comprised of one way glass or the like.

In use, the structure 12 is positioned in a selected spot outdoors for the purposes of hunting. Each of the fasteners 34 is fastened to the inside surface 16 of the structure 12. Each of the first 24 and second 28 curtains is suspended on the inside surface 16 of the structure 12 through any conventional means. Moreover, the first lateral edge 26,30 corresponding to each of the first 24 and second 28 curtains is aligned with the first opening 18. Each of the chains 36 is suspended from an associated one of the fasteners 34 to align the window 42 with the first opening 18 and the second opening 32. In this way the prey is visible from the interior of the structure 12 and the prey cannot see into the interior of the structure 12. The weapon 20 is extended between the first 24 and second 28 curtains and outwardly through the first opening 18 to kill the prey.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hunting blind system comprising:
a structure being configured to house a hunter, said housing having a first opening extending into an interior of said structure wherein said first opening is configured to have a weapon extended therethrough for hunting; and
a shield unit being positioned within said structure such that said shield unit covers said first opening, said shield unit being comprised of a polarized material wherein said shield unit is configured to pass light therethrough in a single direction thereby inhibiting prey from seeing through said shield unit.

2. The system according to claim 1, wherein:
said structure has an inside surface; and
said shield unit comprises a first curtain being suspended on said inside surface of said structure, said first curtain having a first lateral edge, said curtain being positioned such that said first lateral edge is aligned with said first opening in said structure.

3. The system according to claim 2, further comprising a second curtain being suspended on said inside surface of said structure, said second curtain having a first lateral edge, said second curtain being positioned such that said first lateral edge of said second curtain is aligned with said first opening in said structure wherein each of said first curtain and said second curtain is configured to facilitate the weapon to be extended between said first lateral edge of said first curtain and said first lateral edge of said second curtain.

4. The system according to claim 3, wherein said second curtain has a second opening extending therethrough, said second opening being aligned with said first opening wherein said second opening is configured to facilitate the prey to be visible through said second opening and said first opening.

5. The system according to claim 1, further comprising a pair of fasteners, each of said fasteners being selectively coupled to an inside surface of said structure, each of said fasteners being positioned above said first opening.

6. The system according to claim 5, further comprising a pair of chains, each of said chains having a first end and a second end, said first end corresponding to each of said chains being releasably coupled to an associated one of said fasteners.

7. The system according to claim 6, further comprising:
a second curtain having a second opening; and
a window being coupled to said second end corresponding to each of said chains, said window having a first surface and a second surface, said window being coupled to said second end corresponding to each of said chains having said first surface facing an interior of said structure, said window being aligned with each of said first opening and said second opening.

8. The system according to claim 7, wherein said window is comprised of a polarized material wherein said window is configured to pass light between said first surface and said second surface, said window being configured to inhibit light from passing between said second surface and said first surface thereby inhibiting the prey from seeing into said structure.

9. A hunting blind system comprising:
a structure being configured to house a hunter, said structure having a perimeter wall, said perimeter wall having an inside surface, said perimeter wall having an first opening extending into an interior of said structure wherein said first opening is configured to have a weapon extended therethrough for hunting; and
a shield unit being positioned within said structure such that said shield unit covers said first opening, said shield unit being comprised of a polarized material wherein said shield unit is configured to pass light therethrough in a single direction thereby inhibiting prey from seeing through said shield unit, said shield unit comprising:
a first curtain being suspended on said inside surface of said structure, said first curtain having a first lateral edge, said curtain being positioned such that said first lateral edge is aligned with said first opening in said structure,
a second curtain being suspended on said inside surface of said structure, said second curtain having a first lateral edge, said second curtain being positioned such that said first lateral edge of said second curtain is aligned with said first opening in said structure wherein each of said first curtain and said second curtain is configured to facilitate the weapon to be extended between said first lateral edge of said first curtain and said first lateral edge of said second curtain, said second curtain having a second opening extending therethrough, said second opening being aligned with said first opening wherein said second opening is configured to facilitate the prey to be visible through said second opening and said first opening,
a pair of fasteners, each of said fasteners being selectively coupled to said inside surface of said structure, each of said fasteners being positioned above said first opening,
a pair of chains, each of said chains having a first end and a second end, said first end corresponding to each of said chains being releasably coupled to an associated one of said fasteners, and
a window being coupled to said second end corresponding to each of said chains, said window having a first surface and a second surface, said window being coupled to said second end corresponding to each of said chains having said first surface facing an interior of said structure, said window being aligned with each of said first opening and said second opening, said window being comprised of a polarized material wherein said window is configured to pass light between said first surface and said second surface, said window being configured to inhibit light from passing between said second surface and said first surface thereby inhibiting the prey from seeing into said structure.
